(19) United States
(12) Patent Application Publication
(10) Pub. No.: US 2026/0049033 A1
(43) Pub. Date: Feb. 19, 2026

(54) Surface Treatment Method

(71) Applicant: DELTA OF SWEDEN AB, Halmstad (SE)

(72) Inventors: Krister THURESSON, Halmstad (SE); Staffan THURESSON, Halmstad (SE); Jonas MODELL, Halmstad (SE)

(21) Appl. No.: 18/996,149

(22) PCT Filed: Jul. 19, 2023
(86) PCT No.: PCT/EP2023/070073

§ 371 Date: Jan. 17, 2025

(30) Foreign Application Priority Data
Jul. 9, 2022 (GB) 2210567.0

(51) Int. Cl. C04B 20/10; C04B 14/06; C04B 26/18; C04B 28/00

(52) U.S. Cl. CPC C04B 20/1051; C04B 14/06; C04B 20/1059; C04B 26/18; C04B 28/00

(57) ABSTRACT

The present invention provides a method of colouring and surface treating the surface of a particulate material, such as a silica-based material like sand, where the method includes the steps of: a) optionally heating the particulate material to a temperature between 3° and 85° C.; b) preparing an aqueous dispersion of a colourant, an alkoxy silane, a silyl alkanoate, a polysiloxane, or a mixture of these; c0) optionally treating the particulate material c1) mixing the dispersion prepared in step b) with the particulate material of step a); c2) optionally adding an alkoxy silane, a silyl alkanoate, a polysiloxane, or a mixture of these; c3) heating the mixture to a temperature of between 2° and 80° C. for a period of 1 minute to 24 hours; and d) optionally mixing the treated sand formed in step c) with an aqueous dispersion of a colourant, an alkoxy silane, a silyl alkanoate, a polysiloxane, or a mixture of these. Steps a) (where used) and b) can be conducted simultaneously or sequentially in either order. At least one step includes the use of an alkoxy silane, a silyl alkanoate, and/or a polysiloxane. At least one step includes use of a colourant. The aqueous dispersion of step d) may be the same or different to that of step b). The invention further provides a coloured particulate material which is surface modified on at least one surface with a colourant and at least one of a silyl alkyl group or silyl alkenyl group. The material may be made by the method of the invention. The invention also provides filled moulding material comprising the coloured particulate filler material.

### FIELD OF THE INVENTION

The present invention relates to surface treatments for particulate materials. In particular, the present invention relates to simple methods for surface treatment (such as hydrophobic surface treatment) of silica-based particulate materials such as sand. The invention further relates, to particulate materials with such surface treatments and to moulding materials comprising such surface-treated particulate material and at least one binder material.

### BACKGROUND TO THE INVENTION

Moulding compositions typically comprise a binder material such as an organic polymer or silicone binder and an inert filler material such as a particulate mineral filler. The filler material adds bulk to the composition and modifies the feel and physical properties of the composition.

It is important when formulating a filled composition, such as a moulding composition, to consider the compatibility of the binder component and the filler component. In particular, if the adhesion of the binder to the filler material is significantly less than the cohesion of the binder to itself then the filler may not remain stably incorporated within the binder. As a result, filler may be lost from the composition, especially when handled or in contact with certain other materials such as water.

The phenomenon of losing filler from moulding compositions is typically more problematic with incompatible fillers, large filler particle sizes and/or under extreme conditions such as high or low temperature, high humidity or contact with solvents such as moisture. This means that in some cases the types of filler and/or the use conditions of use are restricted due to incompatibility between the filler and the binder.

Many common fillers such as sand, glass, silica and many ceramics have a high silica (SiO₂) content. These can be highly compatible with certain silicone-based binders, but are not always sufficiently compatible with all binders, particularly those based upon organic polymers. This can lead to difficulties during the manufacture of the composition and/or may result in loss of binder during use, either in routine use or under conditions of high humidity or moisture contact.

Furthermore, it is common for filled compositions, such as moulding compositions, to be coloured. Typically, the desired pigmentation is achieved through colouration of the binder composition. It would be an advantage if the filler material could additionally be coloured, to achieve a unique pattern of colours. Alternatively, it would be an advantage to colour the filler material instead of the binder material, as the binder is often used in a much lower concentration in the final filled composition. It is often difficult, however, to apply a stable colourant to the surface of a filler. For example, the resulting coloured filler may suffer from pigmentation leakage when contacted with water.

It would be a considerable advantage if a method could be found to increase the compatibility of silica-containing particulate materials for a wide variety of binders such as organic polymer binders and/or silicone based binders. It would be a further advantage if the treatment reduced the loss of filler from a filled material in use. It would be a further advantage if the treatment reduced the amount of binder necessary to effectively and/or stably coat the filler. It would be a still further advantage if such a method could use moderate conditions, short durations and/or mild reagents for ease of manufacture. It would be a yet still further advantage if only a small quantity (wt %) of surface treatment reagent was necessary to improve the properties of the particulate filler. It would be a further advantage if the particulate filler could be simultaneously surface treated and coloured. Such colouration will advantageously be uniform and effectively immobilized, suffering from little or no leakage (e.g. in use and/or in water).

### SUMMARY OF THE INVENTION

The present inventors have now established that compatibility of particulate materials (especially silica-based fillers) with many binders, particularly binders comprising organic polymers and/or siloxane polymers, can be improved by surface-treatment of the particulate material using at least one alkoxy silane.

In the first aspect, the present invention provides a method of surface treating and optionally colouring at least one surface of a particulate material, the method comprising:
a) optionally heating the particulate material to a temperature between 3° and 85° C.;
b) preparing an aqueous dispersion of at least one material selected form a colourant, at least one alkoxy silane, at least one silyl alkanoate, at least one polysiloxane, and mixtures thereof,
c1) mixing the dispersion prepared in step b) with the particulate material of step a);
c2) optionally adding at least one material selected from at least one alkoxy silane, at least one silyl alkanoate, at least one polysiloxane, and mixtures thereof,
c3) heating the mixture to a temperature of between 2° and 80° C. for a period of 1 minute to 24 hours; and
d) optionally mixing the treated sand formed in step c) with an aqueous dispersion of at least one colourant and/or at least one alkoxy silane and/or at least one silyl alkanoate and/or at least one polysiloxane.
   wherein steps a) (where used) and b) can be conducted simultaneously or sequentially in either order, where at least one step (e.g. at least one of steps b), c2) and/or d)) includes the use of (e.g. adding) a material selected from at least one alkoxy silane, at least one silyl alkanoate, and/or least one polysiloxane and wherein the aqueous dispersion of step d) may be the same or different to that of step b) and wherein at least one step (e.g. at least one of steps b), c2) and/or d)) may optionally include a colourant.

As referred to herein, “step c” will comprise steps c1), optionally step c2), and step c3), where context allows. Step c) in any method herein may include an optional treatment of the particulate material with a basic solution (e.g. an alkali metal hydroxide solution). This may be considered optional step c0).

Thus, the following two descriptions may be considered equivalent:
c) mixing the dispersion prepared in step b) with the particulate material of step a) and heating the mixture to a temperature of between 2° and 80° C. for a period of 1 minute to 24 hours; and
c1) mixing the dispersion prepared in step b) with the particulate material of step a); and
c3) heating the mixture to a temperature of between 2° and 80° C. for a period of 1 minute to 24 hours;

In another aspect, the present invention provides a method for surface treatment of at least one surface of a particulate material, the method comprising;
a) optionally heating the particulate material to a temperature of between ambient (e.g. 20° C.) and 85° C., such as between 3° and 85° C.;
b) preparing an aqueous dispersion of at least one alkoxy silane and/or at least one silyl alkanoate; and
c) mixing the dispersion prepared in step b) with the particulate material of and heating the mixture to a temperature of between 20° C. and 80° C. for a period of 1 minute to 24 hours;
wherein steps a) (when used) and b) can be conducted simultaneously or sequentially in either order.

Where no heat is applied in step a) this step consists of obtaining an appropriate particulate material in all appropriate embodiments.

In one embodiment, the surface treatment is a hydrophobic surface treatment.

The methods of the invention may additionally be used to both surface-treat (e.g. hydrophobise) the surface of particulate materials and colour their surface. In a corresponding aspect, the invention thus provides a method as described in the first aspect for concomitantly surface treating and colouring said particulate material, said method further comprising;
d) mixing the treated particulate material formed in step c) with an aqueous dispersion of at least one colourant and optionally at least one alkoxy silane, at least one silyl alkanoate and/or at least one polysiloxane.

Colouring and surface treatment (e.g. hydrophobising) may be carried out in a single step according to a further aspect of the invention, which provides a method of colouring and surface treating at least one surface of at least one particulate material, the method comprising;
a) obtaining and optionally heating a particulate material (preferably a non-surface modified particulate material) to a temperature of between ambient (e.g. 20° C.) and 85° C. (e.g. between 3° and 85° C.);
b) preparing an aqueous dispersion of at least one alkoxy silane and/or at least one silyl alkanoate and at least one colourant; and
c) mixing the dispersion prepared in step b) with the particulate material of and heating the mixture to a temperature of between 2° and 80° C. for a period of 1 minute to 24 hours;
wherein steps a) and b) can be conducted simultaneously or sequentially in either order.

In a further aspect, the present invention provides a method of colouring and surface treating at least one surface of at least one particulate material, the method comprising;
a) optionally heating the particulate material to a temperature of between 3° and 85° C.;
b) preparing an aqueous dispersion of: at least one colourant; and
c0) optionally pre-treating the particulate material with a basic solution
c1) mixing the dispersion prepared in step b) with the particulate material of step a)
c2) adding at least one material selected from at least one alkoxy silane, at least one silyl alkanoate, at least one polysiloxane, and mixtures thereof, and
c3) heating the mixture to a temperature of between 2° and 80° C. for a period of 1 minute to 24 hours;
wherein steps a) (when used) and b) can be conducted simultaneously or sequentially in either order.

The materials generated by the methods of the present invention are highly useful, particularly for use as fillers in combination with polymeric binders since the surface-treated particles have high compatibility with many binders, particularly polymeric binders.

In a further aspect, the invention provides a particulate material surface modified on at least one surface with at least one silyl alkyl group or silyl alkenyl group. Such particulate material may also be additionally coloured on the at least one modified surface. Such modification and optional colouring may be carried out as described herein.

In a further aspect, the invention thus provides a particulate material having at least one treated (e.g. hydrophobised) surface formed or formable by treatment with an aqueous dispersion of at least one alkoxy silane. This will generally be at least one treated (e.g. hydrophobised) surface formed or formable by the method described herein for all appropriate aspects and embodiments of the invention.

In a further aspect, the invention thus provides a coloured particulate material having at least one modified (e.g. hydrophobised) surface. This is preferably a surface modified particulate material (such as sand) having a silica content of at least 50% by weight of the particulate material (e.g. as described herein). The coloured particulate material may be formed or formable by any of the methods described herein.

In a still further aspect, the invention provides a filled moulding material comprising at least one particulate filler material and at least one polymeric binder material, wherein the particulate filler material has at least one treated (e.g. hydrophobised) surface, modified with at least one silyl alkyl group or silyl alkenyl group (and preferably also coloured as described herein). Highly suitable binder materials include, for example, siloxane polymers, polyesters (e.g. polycaprolactone homo-polymers or copolymers) and polyvinyl acetate homo-polymers or copolymers.

The moulding materials of the invention are typically mouldable by hand at at least one temperature between 2° and 45° C. The moulding materials are generally not elastomeric. Although the moulding materials may harden and become rigid materials at temperatures below, for example, 30° C. (e.g. 15-30° C.), they generally do not set or cure (e.g. by chemical reaction) and can be re-softened and mouldable again by hand when warmed to at least one temperature between 2° and 45° C.

In a yet further aspect, the present invention provides a method for improving the compatibility of a particulate material with a binder, the method comprising
a) optionally heating the particulate material to a temperature of between 3° and 85° C.;
b) preparing an aqueous dispersion of at least one alkoxy silane and/or at least one silyl alkanoate; and
c) mixing the dispersion prepared in step b) with the particulate material of step a) and heating the mixture to a temperature of between 2° and 80° C. for a period of 1 minute to 24 hours;
wherein steps a) and b) can be conducted simultaneously or sequentially in either order.

The method may include concomitantly colouring the particulate material

In a related aspect, the invention provides a method for improving the compatibility of a particulate material with a binder and concomitantly colouring the material, the method comprising
a) optionally heating the particulate material to a temperature of between 3° and 85° C.;
b) preparing an aqueous dispersion of at least one material selected from at least one alkoxy silane, at least one silylalkanoate, at least one polysiloxane and a colourant; and
c1) mixing the dispersion prepared in step b) with the particulate material of step a);
c2) optionally adding at least one material selected from at least one alkoxy silane, at least one silyl alkanoate, at least one polysiloxane, and mixtures thereof,
c3) heating the mixture to a temperature of between 2° and 80° C. for a period of 1 minute to 24 hours; and
   d) optionally mixing the treated sand formed in step c) with an aqueous dispersion of at least one colourant and/or at least one alkoxy silane and/or at least one silyl alkanoate and/or at least one polysiloxane.wherein steps a) and b) can be conducted simultaneously or sequentially in either order;
   wherein at least one step (e.g. at least one of steps b), c2) and/or d)) includes the use of a material selected from at least one alkoxy silane, at least one silyl alkanoate, and/or least one polysiloxane;
   wherein the aqueous dispersion of step d) may be the same or different to that of step b); and
   wherein at least one step includes a colourant.

In a yet still further aspect, the invention correspondingly provides a filled moulding material comprising at least one particulate filler material and at least one polymeric binder material, wherein the particulate filler material has at least one treated (e.g. hydrophobised) surface formed or formable by treatment with an aqueous dispersion of at least one alkoxy silane. Such treatment will generally be generating at least one treated (e.g. hydrophobised) surface formed or formable by any of the methods described herein for all appropriate aspects and embodiments of the invention. Highly suitable binder materials include, for example, siloxane polymers, polyesters (e.g. polycaprolactone homo-polymers or copolymers) and polyvinyl acetate homo-polymers or copolymers.

In a yet still further aspect, the invention provides a filled moulding material comprising at least one coloured particulate filler material and at least one polymeric binder materials, wherein the coloured particulate filler material has at least one treated (e.g. hydrophobized) surface, modified with at least one silyl alkyl group or silyl alkenyl group and a colourant. The coloured particulate filler material is preferably a material formed or formable by any of the methods described herein in any compatible embodiment.

### DETAILED DESCRIPTION OF THE INVENTION

Without being bound by theory, it is believed that much of the incompatibility of silica-containing fillers with binders such as organic polymer binders is a result of the filler material having a hydrophilic surface. This may, at least in part, be due to the presence of silanol (Si—OH) groups on the surface of the particles. This applies particularly to materials comprising at least one silica component and especially particles having silica at least partially at the surface.

The present inventors have now developed a method for modifying the functional groups (e.g. silanol functional groups) at the surface of particulate materials such that the particle surface is modified to become more readily compatible with binders such as organic polymer binders and/or siloxane polymer binders. In one embodiment the modification is a hydrophobic surface modification. In a related embodiment, the particle surface becomes more hydrophobic and/or less hydrophilic after treatment than prior to treatment. In a further embodiment, the treated surface is more compatible with binder materials such as organic polymer binders and/or siloxane binders than the untreated surface. In a further embodiment, the treated surface is resistant against leakage of any coloured pigmentation (e.g. as described herein).

All appropriate aspects of the present invention utilise at least one alkoxy silane and/or at least one silyl alkanoate, and/or least one polysiloxane (preferably at least one alkoxy silane and/or at least one silyl alkanoate)., which is utilised in the form of a dispersion in a solvent. This is preferably as a dispersion in an aqueous solvent such as water (e.g. distilled or deionised water). The preparation of the alkoxy silane dispersion is step b) of the method described herein and may occur before, after or during heating step a) described herein. In one embodiment, a mixture of at least two alkoxy silanes and/or silyl alkanoates are used. Mono- or di-alkoxy silanes may be used but tri-alkoxy silanes form a preferred embodiment. Similarly, silyl mono- or di-alkanoates may be used but silyl tri-alkanoates form a preferred embodiment.

In one embodiment, mono-alkoxy silanes and/or silyl mono-alkanoates are used as the silyl component in step b) and/or d).

In one embodiment, the silanes used in the invention may comprise, consist essentially of or consist of monofunctional silanes (e.g. mono-alkoxy silanes and/or mono-alkyl silanes).

In one embodiment, the silanes used in the invention may comprise, consist essentially of or consist of di-functional silanes (e.g. di-alkoxy silanes and/or di-alkyl silanes).

In a still further embodiment, the silanes used in the invention may comprise, consist essentially of or consist of a mixture of mono-functional silanes and di-functional silanes (e.g. a mixture of at least one di-alkoxy silane and/or di-alkyl silane with at least one mono-alkoxy silane and/or mono-alkyl silane).

In one embodiment of the invention, the at least one alkoxy silane comprises i) at least one alkoxy vinyl silane and ii) at least one alkoxy alkyl silane. These may be, for example, at least one tri-alkoxy vinyl silane and one tri-alkoxy alkyl silane.

In one embodiment of the invention, the at least one alkoxy silane comprises i) at least one alkoxy vinyl silane and ii) at least one alkoxy alkyl silane at a weight ratio of i) to ii) between 99:1 and 50:50. This may be, for example, a ratio of between 98:2 and 70:30 or between 97:3 and 80:20 by weight.

Suitable alkoxy silanes for all embodiments of the present invention include silanes of formula i) below:

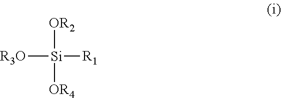

wherein:
R1 is selected from H; CH₃; C2 to C12 cyclic, branched or straight chain alkyl groups; C2 to C12 branched or straight chain alkenyl groups and mixtures thereof;
each of R2, R3 and R4 is independently selected from H; CH₃; C2 to C8 branched or straight chain alkyl groups; and mixtures thereof.

In one embodiment, R1 may be an alkenyl group, preferably a C2 to C4 hydrocarbyl group with a terminal double bond. In one particular embodiment, R1 may be a vinyl group.

In another embodiment, R1 may be a straight-chain, branched chain or cyclic alkyl group having 2 to 12, preferably 2 to 8 carbons. Branched hexyl or octyl groups such as trimethyl pentyl groups form one preferred embodiment.

In another embodiment, R1 may be selected from H; CH₃; C2 to C12 cyclic, branched or straight chain alkyl groups; C2 to C12 alkyl or alkenyl group comprising at least one oxygen-containing functional group (e.g. at least one ether link and/or at least one epoxy group); and/or C5 to C10 aromatic groups, such as a substituted or unsubstituted phenyl ring.

In another embodiment, R1 may be selected from H; CH₃; C2 to C7 cyclic, branched or straight chain alkyl groups; C2 to C7 alkyl or alkenyl group comprising at least one ether link and/or at least one epoxy group.

In another embodiment, R1 may be selected from H; CH₃; C2 to C7 cyclic, branched or straight chain alkyl groups; and/or at least one C5 to C7 aromatic group optionally substituted with at least one methyl and/or ethyl group.

Where a moiety is described as “substituted”, this will preferably be with at least one CH₃; C2 to C7 cyclic, branched or straight chain alkyl group.

In one embodiment, each of R2 to R4 may independently be a H; CH₃; C2 to C6 branched or straight chain alkyl groups; and mixtures thereof. Methyl, ethyl and propyl groups are particularly suitable for R2, R3 and R4. While each of R2 to R4 may be selected independently (including from the options indicated herein), in one embodiment each of R2 to R4 may represent the same group. Thus, in one embodiment, each of R2 to R4 may be methyl or each of R2 to R4 may be ethyl.

In a preferred embodiment applicable to any appropriate aspect of the invention, the at least one alkoxy silane comprises i) trialkoxy vinyl silane (e.g. C1-C4 alkoxy) and ii) trialkoxy trimethylpentyl silane (e.g. C1-C4 alkoxy). In a still further preferred embodiment, the at least one alkoxy silane comprises i) trimethoxy vinyl silane and ii) triethoxy trimethylpentyl silane. Ratios discussed above for components i) and ii) apply equally to these embodiments.

In a further embodiment, triethoxy trimethylpentyl silane may be present in an amount of 1 to 50%, such as 2 to 30% or 5 to 15% by weight of all silane compounds used in the methods and other aspects of the invention.

In a further embodiment, trimethoxy vinyl silane may be present in an amount of 50 to 99%, such as 70 to 98% or 85 to 95% by weight of all silane compounds used in the methods and other aspects of the invention.

A further suitable silane material usable as all or part of the silane in the silane dispersion(s) may be at least one silyl alkanoate. This may be of formula ii) below:

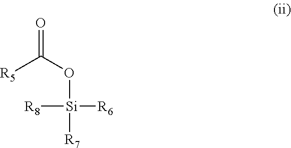

wherein R5 is selected from C1 to C6 alkyl groups, preferably a methyl group;
each of R6 and R7 is independently selected from R9, —O—R9 and —O—CO—R9, where R9 is selected from H; CH₃; C2 to C12 cyclic, branched or straight chain alkyl groups
and R8 is selected from H; CH₃; C2 to C12 cyclic, branched or straight chain alkyl groups; C2 to C12 branched or straight chain alkenyl groups and mixtures thereof;

In one embodiment, R5 is methyl or ethyl, preferably methyl.

In one embodiment, both R7 groups are —O—R9 or —O—CO—R9 groups, preferably —O—CO—R9 groups.

In one embodiment, R9 is methyl or ethyl, preferably methyl.

In one embodiment, R8 is an alkenyl group, preferably a C2 to C4 hydrocarbyl group with a terminal double bond. In one particular embodiment, R8 may be a vinyl group.

The silane compound(s) are generally utilised in the form of a dispersion, particularly an aqueous dispersion (e.g. in water such as distilled or deionised water). The total silane content of the dispersion may be, for example, 0.1 to 50% by weight, preferably 0.5 to 30% or 0.5 to 20% by weight, such as 1 to 10%, 5 to 20% or 5 to 15% by weight of the dispersion. Suitable dispersions may be of any effective type including suspensions, colloidal dispersions and/or solutions.

The total weight of aqueous silane dispersion (including the water component) will generally be as little as possible while still maintaining the ability to “wet” (substantially coat the surfaces of) the particulate material. In some embodiment, especially with smaller-scale batches (such as less than 10 kg) the mass of the dispersion may be up to around 5% or even 10% of the mass of the particulate material (e.g. sand). In other embodiments, particularly in large scales such as 100 kg to 10000 kg, the amount of dispersion the mass of the dispersion may be no more than around 0.5% or even 0.1% of the mass of the particulate material (e.g. sand). The present inventors have surprisingly found that even amounts less than 1% by weight (e.g. 0.1 to 1%) are sufficient to substantially coat the surfaces of the particulate material (e.g. coat greater than 75%, preferably greater than 95% of the surfaces).

The various aspects of the present invention relate to the surface-coating of particulate materials. These materials will particularly be materials which comprise at least one metal oxide. Typical metal oxides which constitute particulate materials (e.g. fillers) include silica (SiO₂), alumina (Al₂O₃), titania (TiO₂) and mixtures thereof both with each other and with other minerals. Preferred particulate materials include those with silicate and/or silica (SiO₂) as a constituent mineral. In one embodiment, at least 50% (e.g. 50 to 100%) by weight of the particulate material is comprised of SiO₂ (e.g. silica and/or silicate measured as SiO₂). This will preferably be 60 to 99.9% or 70 to 95% (e.g. 75 to 90%) SiO₂. In one particular embodiment, the particulate material may be formed of sand having a SiO₂ content of 80 to 100% by weight, preferably 85 to 100% by weight, most preferably 90 to 99.9% by weight, such as silica sands having 98.5 to 99.9% SiO₂ by weight. Other forms of silica are also highly suitable particulate materials.

Example materials which comprise SiO₂ include silica (e.g. crystalline silica including quartz, tridymite and cristobalite, silica gel and/or fumed silica), rock (e.g. crushed rock), soda-lime glass, borosilicate glass, silica sand, quartz sand, building sand and related materials as well as all mixtures. Evidently, materials are suitable at any manageable particle size and thus, for example, “silica sand” as indicated herein is used to indicate a silica material with grain sizes (e.g. weight average grain sizes or d50 sizes) of around 0.05 to 2 mm, as is conventional for sand, but particles from 0.05 down to 0.004 mm, which might be considered “silt” and those from 0.004 to 0.001 mm (4 to 1 m) which might be considered “clay” are also suitable for use in the present invention. Similarly, “pebble” sizes from 2 mm to around 10 mm may also be used. These sizes are appropriate for all particulate materials indicated herein and not simply for sands. Glass particles, for example, may also range from 1 m to 10 mm, as may particles of all other materials. Typical “sand” sizes of around 50 m to 2 mm are highly suitable, however. In one embodiment, the particulate material is not “nano” sized (e.g. having a particle size of 100 nm or less). In a related embodiment, the particulate material is not nano-silica. In a related embodiment, the particulate material is not nano-titania.

The particulate material may have a “bimodal” or “multimodal” size distribution. For example, the particles may comprise some “clay” or “silt” sized particles and some “sand” or “pebble” sized particles. This may be particularly suitable for the filler applications of the particulate materials since small particles can be accommodated in the spaces between larger particles of material. In one embodiment, where there is a bi-modal size distribution, the two peaks (maxima) in the size distribution curve will occur at sizes where the larger particles are at least 2 times (e.g. 2 to 1000), preferably at least 3 times or at least 5 times larger than the smaller particles. This will help in the “space-filling” characteristics. Corresponding ratios may apply to multi-modal distributions with more peaks.

In one embodiment, the particulate material is not a naturally occurring material (i.e. a material from a living organism) such as a plant material or an animal material. For example, the particulate material is not wood or hemp fibre.

The amount of silane used in the various methods of the present invention and thus correspondingly present on the surface of the particulate materials in various aspects of the present invention is around 0.01 to 1% by weight of the particulate material.

In one embodiment, the amount of silane used in the methods of the invention and correspondingly the amount of silane present at the surface of the modified particles may be in the range of around 1 to 200 mg of silane per square meter of particle surface area. This may be, for example around 5 to 100 mg/m² or around 8 to 70 (e.g. 8 to 35) mg/m². Corresponding calculations can be made for all aspects and embodiments of the invention.

In the methods of the present invention, step a) comprises the option step of pre-heating of the particulate material. This step is not essential but is found to improve the method in many cases. Without being bound by theory, this is believed to help remove volatiles from the surface of the material and increase the rate of reaction once the silane is added. The particulate material may be used at ambient temperature (e.g. 20° C. or more) and will usually be at no more than 100° C. Generally, the particulate material will be heated to a temperature of 30 to 85° C., such as 40 to 75° C. A range of 50 to 70° C. has been found to be highly effective. Preferably the particulate material will be heated within these ranges and held at that temperature until ready for contact with the alkoxy silane dispersion. Where no heating takes place, step a) simply represents obtaining the appropriate particulate material, as required.

Part b) of the methods of the invention comprises the preparation of an aqueous dispersion of at least one alkoxy silane in water. Suitable silanes for all aspects of the invention are discussed herein and any appropriate alkoxy silane or mixture thereof may be used in any aspect or embodiment where technically feasible.

The concentration of silane in the aqueous dispersion may be varied within a wide range while still allowing effective surface treatment of the particulate material. For example, a concentration of at least 0.1% silane by weight in water may be effective, preferably at least 0.2% or 0.5%. However, concentrations of up to 1%, such as up to 2%, up to 2.5% or up to 5% may be used. Higher concentrations of up to 10% or up to 20% may also be appropriate. It is typically preferable to use less water, and thus higher silane concentrations, at larger batch sizes since mixing may be easier and the water is more time-consuming to remove at larger scales.

The formation of the silane dispersion may take place before, during or after the heating step a). In one embodiment, the dispersion is made up shortly before use to avoid degradation of the silane material in water. In one embodiment, the silane dispersion may be mixed for around 10 to 180 minutes before use. This may be, for example, 20 to 120 minutes or 30 to 60 minutes.

In one embodiment, the silane dispersion may be prepared at slightly acidic pH such as pH 2 to 6, preferably pH 3 to 5, such as around pH4. This may serve to decrease the degradation of the silane prior to use. pH may be adjusted with any appropriate acid or base material as appropriate, although an acid such as an organic acid (e.g. acetic acid) is likely to be appropriate. Addition of acetic acid until the dispersion is at pH 4±0.5 is a highly appropriate embodiment.

In one embodiment, applicable to any compatible aspect of the present invention, the particulate material may be treated with a basic solution prior to the surface treatment, such as with a metal hydroxide such as sodium hydroxide (e.g. NaOH (1 M)). Treating the particulate material (i.e. sand) with a basic solution may provide better immobilization of the pigmentation and water resistance.

When epoxysilanes are used for the surface treatment of sand, then a method involving basic treatment of the sand prior to the silane treatment is favoured.

Mixing of the silane dispersion with the heated particulate material is step c) of the method and occurs after steps a) and b). This mixing may be at any effective temperature but will preferably be at a temperature sufficient to remove the water from the mixture, such as between ambient temperature (e.g. 20° C.) and 100° C. This will generally be between 25 and 80° C., such as between 4° and 75° C. (e.g. between 5° and 70° C.). Mixing and heating times will typically be sufficient to remove the water from the mixture and so may vary widely but will generally be between around 1 minute (preferably 5 minutes) and around 24 hours, preferably between 8 minutes and 1 hour (e.g. between 10 minutes and 40 minutes).

The methods of the present invention can additionally be used to colour a particulate material in addition to providing a surface treatment. Typically, the colourant can be prepared as an aqueous solution or dispersion prior to the addition of the silane (e.g. silane dispersion) or simultaneously with the silane dispersion in step b) and thus mixed with the particulate filler in step c). Alternatively, the aqueous dispersion of the colourant may be added after the filler material has been mixed with the silane dispersion in an additional step d). An aqueous dispersion of the colourant must be prepared and mixed with the particulate filler in at least one of steps c) or d).

In a further embodiment, (e.g. when the sand is not mixed with a colourant dispersion in step c)) the methods described herein may comprise an additional step of:
d) mixing the treated sand formed in step c) (as described in any aspect or embodiment herein) with an aqueous dispersion of at least one colourant.

Evidently, steps c) and d) may be combined as described herein and in any technically viable combination.

Step d) will generally be followed by a heating and/or drying step to “fix” the colour to the particulate surface. This step may use the same conditions as described for step c) herein in any embodiment.

In all embodiments, at least one silane material (e.g. any silane material described herein or any mixture thereof) will be used in at least one step of the surface treatment method. The method may thus be a method for providing a silyl-treated particulate material (e.g. a coloured silyl-treated particulate material).

Suitable colourants for use in the method of the invention include white titanium dioxide, carbon black, organic pigments (e.g. metal complexes, nitrated, hydroxylated and/or halogenated aromatic organic molecules) and inorganic pigments in any suitable colours. Many suitable colourant materials known in the art. In one embodiment, the colourant is not titanium dioxide. In a related embodiment, the colourant does not comprise titanium dioxide.

In one embodiment, the colourant is not a white colourant.

In one embodiment, the colourant is not a carbon colourant. Carbon colourants include graphite, carbon black, graphene, graphene oxide, etc.

In one embodiment, the colourant is not a black colourant.

Colouration of the particulate material may be used to generate an overall coloured product or may be used to give a whiter or more uniformly coloured particulate material for use as a filler with a coloured or colourless binder material. Such methods may improve the colour intensity of the filled material or simply be used to make the material more uniform by compensating for variations in the colour of the starting filler particulate material. The amount of colourant used may depend upon the effect to be achieved and the intensity of the pigment but may be, for example, 0.01 to 1.5% by weight of the particulate material, such as 0.02 to 0.1% by weight. For certain colours, particularly black and white, larger quantities of dye may be required. In such cases, 0.1 to 1.5%, such as 0.2 to 1% may be the ideal level. For other colours or where lower intensities of black or white are required, 0.01 to 0.2%, such as 0.03 to 0.1% may be sufficient.

Mixtures of dyes may evidently be used including mixtures of any appropriate colour combinations. In one embodiment, while TiO₂ pigment may be used along with another colour (preferably not black) in order to achieve a particularly vivid effect.

Colouration of the particulate material may be conducted in one step or two, as described herein. Where this is conducted in two steps, the aqueous dispersion of colourant may be mixed with a silane material. This may be an alkoxy silane as described herein and/or a silyl alkanoate as described herein. Additionally or alternatively, a polysiloxane may be used, such as an aminated poly alkyl siloxane such as Poly[3-((2-aminoethyl)amino) propyl]methyl(dimethyl) siloxane. The polysiloxane may be used in an amount of around 0.001 to 0.1% by weight (e.g. 0.001 to 0.1%) of the amount of particulate materials and may be present in the dispersion at, for example, 0.1 to 10% by weight, such as around 1%. The coloured materials as described herein in any suitable aspect or embodiment may be “stable” to the loss of colouration. A material is considered stable to loss of colouration if, when 50 g of coloured material is contacted with 1 L of water at 20° C., under magnetic stirring at 120 rpm, for 5 minutes, and allowed to settle, a sample of the water showed an absorbance of less than 0.5 AU over a 1 cm path at the visible wavelength of highest absorbance. This will preferably be less than 0.3 AU, more preferably less than 0.2 AU or less than 0.1 AU for a 1 cm path at the visible wavelength of greatest absorbance. A practical test is simply that after a few minutes stirring the water should be hardly coloured to the naked eye.

The surface-treated particles of the present invention are highly suitable for use as fillers in moulding compositions. Such compositions will typically also include at least one polymeric binder. Suitable binders include silicone-based binders, poly ester, poly amide and substituted aliphatic polymer binders. Particular examples include polyesters such as poly caprolactones (optionally copolymerised with lactate monomers) and substituted aliphatic polymers such as polyvinyl acetate (homo-polymers or copolymers). Silicone binders include polyalkylsiloxane binders, optionally crosslinked with materials such as alkyl silyl alkanoates. Binders may optionally include boron crosslinking, but will preferably have a boron content of no more than 1% by weight of binder. Binders serve to hold the filler material (i.e. a particulate material such as that described herein in any suitable aspect or embodiment) together into a mouldable material. However, even where the binder is a polysiloxane material, this is distinct from the surface modification material of the present invention. In a preferred embodiment, the surface modification is covalently bound to the surface of the particulate material (e.g though binding to Si—OH groups on the surface of a silicate or silica component). The binder preferably does not form (or substantially form) covalent bonds with the particulate material, either with or without the surface modification described herein. Binders are typically polymeric materials which can be dissolved or melted to at least partially coat the particulate material without bonding directly to the surface. In contrast, the “surface modification”, especially by silane materials as described herein may modify the surface of the material by chemical bonding, especially covalent bonding.

In one embodiment, the binder is a thermoplastic polymer. In a related embodiment, the binder is not a curable or thermosetting polymer.

In one embodiment the binder is not a fluorinated polymer. In a further embodiment, the binder is not polytetrafluoroethane (PTFE).

In one embodiment, the binder is not a phenolic resin.

In one embodiment, the binder is not a homopolymer or copolymer of vinyl chloride and/or vinyl isobutyl ether.

It has been found that particulate materials surface treated as described herein may be effectively coated with binder, using around 20% less binder material than is needed for coating untreated fillers. This is believed to reflect the greater compatibility between the binder and the surface of the filler such that the binder “spreads” on the surface more readily.

It has additionally been found that a binder treated with a colourant may be used in combination with to the filler material which has been treated with a colourant (e.g. as described herein), to create a unique visual effect for the resulting filled moulding composition.

In one embodiment, the binder is not an elastomer. For example, the binder is not (i.e. does not comprise more than 10% of) a rubber (e.g. a natural rubber or a synthetic rubber). In another embodiment, the binder is not spandex. In a further embodiment, the binder is not a polyurethane.

In one embodiment, the moulding material is not elastomeric. For example, if a 10 cm×1 cm×3 mm strip is elongated by 20% at 25° C. then it will either break or remain stretched and not return to within 10% of its original length within 10 minutes at 25° C.

Binders typically include additional components such as softeners and/or anti-tack agents and may include additional components such as a pigment; a glitter; a mica or coated mica; a perfume; a preservative; and/or a fire-retardant. Any combination of such additives may be used but will typically be present at no more than 5% by weight (e.g. 0.01 to 5%) of the total composition. This will preferably be no more than 2% or no more than 1% by weight.

As used herein, the term “about”, “around” “substantially” or “approximately” in relation to a number or a range of numbers will generally indicate that the number or range specified is preferred but that such a number may be varied to a certain extend without materially affecting the properties of the relevant material, composition or similar product. The skilled worker will typically be able to readily establish the extent by which such numbers may be varied without prejudicing the key advantages of the present invention. As a general guide, such numbers or the ends of such ranges may be varied by ±10%, preferably ±5% and more preferably ±1%. A corresponding meaning may be attributed to compositions “consisting essentially of” certain components, which may include up to 10%, preferably up to 5% and most preferably up to 1% of other components in addition to those specified. Where a chemical group, chain or other moiety is described herein as optionally substituted, such substitution may be absent or one or more atoms in the moiety (typically one or more hydrogens and/or carbons) may be substituted with groups such as halide (e.g. F, Cl, Br, I) groups, oxygen-based moieties such as ethers, alcohols, esters carboxylic acids or epoxides, nitrogen-based groups such as amines, amides, nitriles or nitro groups, or sulphur-based groups such as thiols, disulphides, thioesters etc. Up to around 10 such substitutions may be made where context allows, but typically 3 or few substitutions, such as 1, 2 or 3 substitutions with independently selected substituent groups will be typical.

As used herein, a “colourant” will have its natural meaning, being a material which imparts a colour in the visible spectrum to a material. Such colourants will typically absorb or reflect at least one wavelength in the visible spectrum (e.g. at least one wavelength between 800 and 400 nm). In one optional embodiment, the colourant may have a colour other than white. In a further optional embodiment, the colourant may have a colour other than white or black. All coloured materials including treated particulate materials referred to herein may be correspondingly interpreted.

The colourant as used herein is preferably an organic or inorganic dye or pigment. Generally, the amount of dye or pigment will be at least 10% (e.g. 10 to 100%) by weight of the colourant. The colourant may be soluble or insoluble in water and may contain a proportion of carrier material such as a polymer. However, it is preferred that the amount of dyes and/or pigments in the colourant will total at least 50% by weight, preferably at least 70% or at least 80%, 85% to 100% may be preferred.

As used herein a “moulding material” is a material that is workable by hand at room temperature or at at least one temperature between 2° and 45° C. (e.g. 20 and 42° C. or 30° C. and 45° C.). In one embodiment, the moulding material does not set in to a permanent shape (i.e. remains mouldable) and may be re-moulded under the same conditions (e.g. at a temperature between 2° and 45° C.). In one embodiment, the moulding material may become rigid at temperatures below 30° C. but will remain mouldable at at least one temperature between 3° and 42° C.

In a favourable embodiment, the “moulding material” is a material which is suitable for children's play, particularly when the material can be played in contact with and under water without significant loss of any component.

The moulding material may be repeatedly formed and re-formed. Where the binder material is solid at room temperature (e.g. a polyester), then the moulding material may be warmed once or repeatedly and formed until a final form is created, at which point the composition can be cooled. Cooling may be simply by leaving the 3-d shape in ambient air or cooled air (e.g. in a refrigerator or domestic freezer) or by immersion in ambient or cooled water. Iced water will serve to essentially instantly “set” the compositions of the invention. Rapid solidification may also be achieved in a refrigerator or domestic freezer.

In one embodiment, the moulding materials of any compatible aspect or embodiment of the present invention will remain mouldable at suitable temperatures (e.g. 25 to 90° C. or 35 to 42° C.). The compositions of the present invention preferably do not “set” or “cure”. That is to say, the compositions of the present invention do no form a rigid material which cannot be reshaped by hand at a suitable temperature (e.g. 35 to 42° C.). As an example, the compositions of the present invention do not set or cure either by chemical reaction or by losing more than 10% of the

### Examples

TABLE 1
Raw materials used in the examples

| Raw material | Supplier | Abbreviation | Composition | Characteristics |
|---|---|---|---|---|
| Geniosil | Wacker | XL10 | trimethoxyvinylsilane | |
| XL10 | Chemie | | | |
| | AG | | | |
| Silres | Wacker | BS1701 | Triethoxy(2,4,4- | |
| BS1701 | Chemie | | trimethylpentyl)silane | |
| | AG | | | |
| Geniosil | Wacker | GF62 | triacetoxyvinylsilane | |
| GF62 | Chemie | | | |
| | AG | | | |
| Silane | Wacker | Silane M3- | Trimethylethoxysilane | Monofunctional |
| M3-ethoxy | Chemie | ethoxy | | silane |
| | AG | | | |
| Liosil | Wacker | HC303E | Poly[3-((2- | Aqueous |
| HC303E | Chemie | | aminoethyl)amino) | dispersion, |
| | AG | | propyl]methyl(dimethyl) | 17% in |
| | | | siloxane | water |
| CROSSLINKER | Wacker | ES23 | Triacetoxy | |
| ES23 | Chemie | | ethylsilane | |
| | AG | | | |
| Trimethoxy- | Sigma- | Trimethyoxy- | Trimethoxy- | Phenyl- |
| phenylsilane | Aldrich | phenylsilane | phenylsilane | containing |
| (97%) | | | | dangling |
| | | | | end group |
| Geniosil | Wacker | GF80 | 3-(2,3- | Epoxy- |
| GF80 | Chemie | | epoxypropoxy)propyl- | containing |
| | AG | | trimethoxysilane | dangling |
| | | | | end group |
| Acetic acid | Local | HAc(24%) | 24% acetic acid in | |
| (24%) | supermarket | | aqueous solution | |
| Sand GA39 | Sibelco | GA39 | 98.8% SiO2 | Specific |
| | | | | weight |
| | | | | 1500 |
| | | | | kg/m3. d50 |
| | | | | ca. 91 |
| | | | | micrometer |
| Sand B15 | Sibelco | B15 | 90.5% SiO2 | Specific |
| | | | 4.9% Al2O3 | weight |
| | | | | 1500 |
| | | | | kg/m3. d50 |
| | | | | ca. 130 |
| | | | | micrometer |
| Sand Mam1s | Sibelco | Mam1s | 99.8% SiO2 | Specific |
| | | | | weight |
| | | | | 1500 |
| | | | | kg/m3. d50 |
| | | | | ca. 205 |
| | | | | micrometer |
| Sand M32 | Sibelco | M32 | 99.5% SiO2 | Specific |
| | | | | weight |
| | | | | 1500 |
| | | | | kg/m3. d50 |
| | | | | ca. 270 |
| | | | | micrometer |
| Sand B55 | Sibelco | B55 | 90.5% SiO2 | Specific |
| | | | 4.9% Al2O3 | weight |
| | | | | 1500 |
| | | | | kg/m3. d50 |
| | | | | ca. 500 |
| | | | | micrometer |
| X-fast stir-in | BASF | X-fast(‘color’) | Mixture, mainly consisting of | |
| pigment | | | pigment and surface active | |
| preparations | | | agent/various colours | |
| VINNAPAS ® | Wacker | B500/40 VL | Poly vinylacetate-co- | |
| B500/40 VL | Chemie | | vinyl laurate | |
| | AG | | | |
| Ingevity | Ingevity | PCL | polycaprolactone | Mw ca. |
| CAPA6500 | | | | 50000D. |
| | | | | Melting |
| | | | | temperture |
| | | | | ca. 60° C. |
| POLYMER | Wacker | CDS100 | Polydimethylsiloxane | Mw ca. |
| CDS 100 | Chemie | | with hydroxy groups | 4000D |
| | AG | | | |
| POLYMER | Wacker | C2T | Polydimethylsiloxane | Mw ca. |
| C 2 T | Chemie | | with hydroxy groups | 20000D |
| | AG | | | |
| Isofol20 | Sasol | I20 | Octyldodecanol | |
| Grindsted | DuPont | MCT60 | medium chain | |
| MCT 60 | Danisco | | triglyceride | |
| Eastman | Eastman | Triacetin | Triacetin | |
| Triacetin | Chemical | | | |
| | Company | | | |
| Eastman | Eastman | Benzoflex 988 | Dipropyleneglycol | |
| Benzoflex 988 | Chemical | | dibenzoate and benzoate | |
| | Company | | esters | |
| Wacker AK10 | Wacker | AK10 | Polydimethylsiloxane | Mw ca. |
| | Chemie | | (PDMS) | 1100D |
| | AG | | | |
| RADIACID 0406 | Oleon NV | Radiacid0406 | Partially hydrogenated | |
| | | | tallow fatty acids | |
| Grindsted Soft- | DuPont | SnS | Acetic Acid Ester | |
| n-Safe | Danisco | | | |
| Hydrochloric | Univar | HCl(9%) | 9% wt hydrochloric acid | |
| acid | | | in aqueous solution | |

As used herein, d50 represents the sieve opening size at which 50% of a sand sample will pass through. Some of the below Examples feature coloured particulate filler materials. To test that the colouration is stable, and there is no leakage from the particulate material, a test may be conducted to assess the immobilization of the pigmentation. The test involves contacting the treated particulate material (approx. 2 g) with an aqueous dispersion, such as pure water (approx. 40 mL) or water comprising hand-dish liquid (approx. 0.5 mL liquid in 40 mL water). The resulting suspension is stirred for several minutes (i.e. 5 minutes) using a magnetic stirrer bar and then the resulting aqueous phase is assessed. If the aqueous phase stays virtually uncoloured after several minutes, the surface modification has effectively immobilized the pigmentation and prevented leakage of the colour. A similar test can be conducted for other solvents, such as ethanol.

### Example 1a—Surface Modification of Sand by an Appropriate Amount and Mix of Silanes

In lab scale the procedure as described below was used as standard to prepare surface treated sand. Acetic acid was used to adjust pH value of the aqueous dispersions to approximately 4, where silane reaction is at minimum. This provides a dispersion where silanes do not react before they meet silanol-groups on the surfaces of the sand grains and the aqueous phase is evaporated. In the first examples (1a and 1b) the treatment took use of a dilute (5% wt) aqueous silane solution/dispersion, while concentration of the dispersion was increased in example 1c.

First the silane dispersion was prepared:
5 g silane was weighed out. When two or more silanes were used, they were first mixed in a beaker with a magnetic stirrer
The silane (mixture) was added to an aqueous solution of 94.5 g water and 0.5 g HAc(24%) under vigorous stirring to provide a solution, dispersion, or course dispersion (depending on the silanes used)
Mixing (vigorous) continued for ca. 30-60 min before contact with heated sand (below)

Surface treated sand was prepared:
2.5 or 5 kg sand (as below) was heated to some 55-60° C. in a stainless-steel pot
The aqueous silane dispersion (100 g—approx. 5% silane in water) was added to the hot sand under continuous mixing
Mixing continued until water had evaporated and the sand was dry

The treatment was assumed to be completed when the sand is dry. In lab-scale testing, the processing time is only a few minutes.

Properties of the treated sand were judged by contacting the sand with pure water. Modification was confirmed by increased hydrophobicity of the particles. This was evaluated by contacting the sand with water to subjectively judge wetting properties and contact angle. It could either be that sand was spread on a flat surface and a drop of water was placed on top of the sand. The surface modification was judged successful if the water stayed as a drop/lens on top of the sand without wetting the sand. An alternative method is to pour modified/treated sand into a large volume of water. Treatment is judged successful if the immersed sand lumps and is not wetted by the water, or alternatively if sand grains are small (approx. 100 micrometer or less), they may float on the water surface. A suboptimal treatment is characterized by that the sand is wetted by water, it does not lump, and small sand grains sink. Table 2 presents selected experiments to show that appropriate hydrophobic properties can be obtained by balancing the selected silane with an appropriate added amount. Preparation D provides very good hydrophobic properties at a low raw materials consumption (0.1 wt % silane to sand ratio). In the following examples was often a silane mix corresponding to Preparation D used (10% wt BS1701 and 90% wt XL10) at an addition level of 0.1% wt. The ‘hydrophobic modification degree on sand surface’ is calculated as the weight of aliphatic moieties on the surface of the particles assuming all silane has reacted and bound to the surface. By example XL10 and GF62 are assumed to provide a vinyl group (27 g/mol).

TABLE 2
Surface modifications of Mam1s

| | Prepa- | Prepa- | Prepa- | Prepa- |
|---|---|---|---|---|
| | ration | ration | ration | ration |
| Raw material | A | B | C | D |
| XL10 | — | — | 5 g | 4.5 g |
| GF62 | 5 g | 5 g | — | — |
| BS1701 | — | — | — | 0.5 g |
| Mam1s | X = 5 kg | X = 2.5 kg | X = 2.5 kg | X = 5 kg |
| ‘Silane | 0.1% wt/10 | 0.2% wt/21 | 0.2% wt/32 | 0.1% wt/17 |
| on sand’/ | mg per m2 | mg per m2 | mg per m2 | mg per m2 |
| ‘hydrophobic | | | | |
| modification | | | | |
| degree on sand | | | | |
| surface’ | | | | |
| Observation | Sub-optimal | OK | Sub-optimal | Very good |
| | hydrophobic | hydrophobic | hydrophobic | hydrophobic |
| | properties | properties | properties | properties |

### Example 1b—Surface Modification of Various Sand Qualities

Various sand qualities (GA39, B15, Mam1s, M32, and B55) were modified following Preparation D above. Since they vary in size of the grains the ‘hydrophobic modification degree on sand surface’ varies despite ‘Silane on sand’ is kept constant to 0.1% wt. The corresponding numbers are d50 ca. 91, 130, 205, 270, and 500 micrometer, which transforms to 8, 11, 17, 23, and 42 mg per m2 in ‘hydrophobic modification degree on sand surface’. The latter is calculated as the weight of aliphatic moieties on the surface of the particles assuming all silane has reacted and is bound to the surface.

By example XL10 and GF62 are assumed to provide a vinyl group (27 g/mol). The silane treated sand versions are abbreviated GA39(ST), B15(ST), Mam1s(ST), M32(ST), and B55(ST).

All sand qualities were successfully modified, and the silane reaction provided hydrophobic properties to the sand qualities as judged by the method above (see Example 1).

For sand M32 it was observed that the result was suboptimal if the temperature fell below some 50° C. Therefore, sand M32 is generally heated some 5 to 10° C. higher than the temperature used for other sand qualities (such as Mam1s). This observation has been rationalized by hypothesizing that upon increasing the temperature ‘some contamination’ is evaporated/removed from the surfaces of the sand grains.

### Example 1c—Large Scale Experiments

The process time in production scale is largely dependent on the time it takes to evaporate the water that stems from the added silane solution/dispersion. For this reason, it is important to minimize the water needed by increasing the concentration of silane in the aqueous solution/dispersion, without jeopardizing the result of the surface treatment.

Mam1s sand was heated in a jacketed steam-heated mixer to 55-60° C. The batch sizes were 400 kg at production scale.

Coarse aqueous silane dispersions were prepared by vigorous mixing for 30-60 minutes. Acetic acid was used to adjust pH value to approximately 4, where silane reaction is at minimum. This provides a dispersion where silanes do not react before they meet silanol-groups on the surfaces of the sand grains and the aqueous phase is evaporated.

The dispersion was then added to the pre-heated sand and mixing continued until the water had evaporated. The treatment was assumed to be completed when the sand is dry. The processing time in large-scale production is around 5-30 minutes (varying according to the amount of water used in the dispersion).

Table 3 presents the compositions of silane dispersion for 400 kg testing. These two versions of silane dispersion are 5% wt and 11% wt, respectively, and give good results of the sand properties as evaluated by the method above. Version B is recommended in large-scale production because it contained less silane (XL10 and BS1701) and water and required less processing time. Water content was reduced by 74% in comparison with Version A, and modification degree was decreased from 17 mg per m2 to 9 mg per m2.

TABLE 3a
Version A

| | For 400 kg | Composition |
|---|---|---|
| Component | Batch (g) | (wt %) |
| XL10 | 375 | 4.5% |
| BS1701 | 42 | 0.5% |
| HAc (24%) | 42 | 0.5% |
| Water | 7875 | 94.5% |
| Total | 8334 | 100% |
| Silane/sand | 0.10% | |
| ratio (%) | | |
| Water/sand | 1.97% | |
| ratio (%) | | |

TABLE 3b
Version B

| | For 400 Kg | Composition |
|---|---|---|
| Component | Batch (g) | (wt %) |
| XL10 | 188 | 9.9% |
| BS1701 | 21 | 1.1% |
| HAc (24%) | 21 | 1.1% |
| Water | 1667 | 87.9% |
| Total | 1896 | 100% |
| Silane/sand | 0.05% | |
| ratio (%) | | |
| Water/sand | 0.42% | |
| ratio (%) | | |

### Example 1d—Water Ratio at Large Scale

Scale-up trials using Version A (see Example 1c) dispersion have been performed on 400 kg batches with various sand types (GA39, Mam1s, M32, B55). All tests have given good and acceptable results. The addition corresponds to some 7.6 L water which must be evaporated. It was found to be time consuming to evaporate 7.6 L and the water amount was decreased in subsequent trial tests, as shown in Table 4 below.

Despite the strongly reduced water volume (and shorter processing time) the result appeared to be unaffected.

400 kg sand M32 was modified with 0.1% silane (40 g BS1701 and 360 g XL10) in a series where water content was decreased. This very much decreased the necessary processing time until all water had evaporated. A starting temperature of about 65° C. was targeted.

TABLE 4
Processing time as a function of water content

| | | | Sand temperature |
|---|---|---|---|
| | | Processing | Before, after |
| Batch | Water/L | time/min | addition/degree C. |
| standard | 7.6 | Long | |
| LP5762 | 5.6 | 32 | 63, 53 |
| LP5762 | 3.6 | 12 | 74, 60 |
| LP5762 | 1.6 | 7 | 65, 57 |

Two large-scale tests on Mam1s sand were also done. Water/sand ratio has been reduced from 0.42% to 0.35%. Silane/sand ratio were 0.05% and 0.03% and both concentrations show good hydrophobic property.

A treatment level of 0.03% could be used as a first step treatment before the coloration. For the second-step treatment of coloration, the colourant/sand ratio can be 0.07% which in total it is 0.1% silane addition, see Example 3 below.

### Example 1e—Surface Modification Following an Alternative Method Using Epoxy Silane

For some silanes, such as epoxysilanes, an alternative method of surface treatment and colouration can provide better immobilization of the pigmentation and water resistance. This alternative method involves treating the sand with a basic solution prior to mixing, and the addition of the colourant prior to the silane.

An example alternative method for modifying the particulate filler includes:
Treating Mam1s (480 g) with 5 mL NaOH (1M) and leaving to rest for ca. 30 minutes
Mixing Mam1s/NaOH with an aqueous solution of X-fast Blue 7080 (0.3 g X-fast in 5 mL water)
Adding 1.5 mL of silane (GF80) and mixing carefully
Allowing the sand to rest for ca. 30 minutes then heating the sand to 80° C. and mixing until dry

To neutralize the NaOH, 2 mL of HCl (9%) can be added followed by careful mixing and drying. After resting overnight, leakage of the pigment from the sand was evaluated. The sand (2 g) was contacted with excess water (40 mL) and mixed with a magnetic stirrer bar. Only mild leakage was observed

### Example 2a—Showing the Benefit of Hydrophobic Modification of the Sand Filler in a Moldable Creative Material Prepared with a Poly Vinylacetate-Co-Vinyl Laurate Based Binder

A binder was prepared by melting Vinnapas B500/40VL at about 100° C. Heat is turned off followed by mixing in long-chained alcohol, followed by adding medium chained triglyceride (Grindsted MCT 60) and triacetin:

| | |
|---|---|
| B500/40 VL | 52.6 g |
| I20 | 36.5 g |
| MCT60 | 4.6 g |
| Triacetin | 6.4 g |

The prepared binder is mixed with sand filler at about 30° C.:

| Binder | 3.8% by weight |
|---|---|
| Sand B55 or Sand B55(ST | 96.2% |

The compound resulting from using untreated Sand B55 is easily reshaped by hand and is useful for children's play. If the material is played with in water the sand filler tends to fall out from the matrix. This is accelerated during drying if the material is played with at the same time.

Preparing the corresponding material, but using silane treated Sand B55, B55(ST), gives similar properties in the dry state. When contacting the material with water B55(ST) opposes the unwanted disintegration. It is now possible to use the material at wet conditions and play in contact with and under water without significant loss of the sand filler.

### Example 2a(ii)—Showing the Benefit of Hydrophobic Modification of the Sand Filler, Using a Monofunctional Silane, in a Moldable Creative Material Prepared with a Poly Vinylacetate-Co-Vinyl Laurate Based Binder

A similar effect is realized for the same binder when mixed with sand treated with a monofunctional silane at about 30° C.:
Binder 5% by weight
Mam1s (silane M3-ethoxy treated): 95% by weight

The aqueous silane solution/dispersion was prepared following a protocol closely like that in Example 1a wherein the silane was M3-ethoxy:
5 g of silane was weighed out
The silane was added to an aqueous solution of 94.5 g water and 0.5 g HAc (24%) under vigorous stirring to provide a solution or dispersion.
Mixing (vigorous) continued for ca. 30 minutes

The sand was first modified with ca. 0.05% silane:
480 g sand Mam1s was heated to some 55-60° C. in a stainless-steel pot
5 g aqueous silane dispersion was added to the hot sand under continuous mixing
Mixing continued until water had evaporated and the sand was dry

The second step was repeated to obtain a surface modification to ca. 0.1% silane on the sand.

The surface treated sand (95%) was then mixed with the polyvinyl acetate-co-vinyl laurate based binder (5%) to provide a material which could be conveniently reshaped and could be used for children's play. A reference material was prepared with the same binder and sand (Mam1s) which had not been surface modified. Both materials were exposed to water during play. The reference material lost most of the sand which fell out from the binder during play, while the silane M3-ethoxy modified material (Mam1s(ST)) was much more stable and tolerated water much better. This shows that monofunctional silane surface treatment is additionally effective for enabling the formation of a moldable material which remains stable and can tolerate water.

### Example 2a(iii)—Showing the Benefit of Hydrophobic Modification of the Sand Filler, Using an Epoxy Silane, in a Moldable Creative Material Prepared with a Poly Vinylacetate-Co-Vinyl Laurate Based Binder

A similar effect is also realized for the epoxy silane modified sand of Example 1e when mixed with the above polyvinyl acetate-co-vinyl laurate binder (of Example 2a(ii)) at about 30° C.:
Binder 5% by weight
Mam1s (GF80 surface treated as in Example 1e): 95% by weight

When compared to a material made with untreated sand, which rapidly loses the majority of the sand filler, the material made with sand treated with GF80 following method of Example 1e resists underwater play to a much larger degree.

### Example 2b—Showing the Benefit of Hydrophobic Modification in a Molding Material Prepared with a Polycaprolactone Based Binder

A binder was prepared by melting polymer PCL at about 70° C. Heat is turned off followed by mixing in Benzoflex 988:

| | |
|---|---|
| PCL | 5.4 g |
| Benzoflex 988 | 9.6 g |

The binder is mixed with sand filler (Sand M32 or M32(ST)) at about 50° C., and then mixed with anti-tacking agent (AK10):

| | |
|---|---|
| Binder | 15 g |
| Sand M32 or M32(ST) | 84 g |
| AK10 | 1 g |

Both compounds (based on Sand M32 or silane treated M32(ST)) are solid at room temperature and softens at about 40° C. In the soft state the material can be reshaped. When cooled the material solidifies again.

When Sand M32 is used as filler the material tends to demix such that the filler falls out from the formula when worked in the warm state. Furthermore, hot water is a convenient way to heat the solid material so that the material becomes malleable. Unfortunately, demixing of the formula accelerates and is pronounced in contact with water when unmodified Sand M32 is used as filler.

By using silane treated M32(ST) as filler instead of Sand M32 demixing is opposed, and the material can be used in contact with water without problem and with no significant loss of filler.

### Example 2c—Showing the Benefit of Hydrophobic Modification in a Molding Material Prepared with a Polycaprolactone Based Binder

A similar effect is realized for the same binder when mixed with sand treated with the monofunctional silane solution of Example 2a(i). The effect of the concentration of silane on the surface treated sand, and the time for mixing the aqueous silane dispersion was evaluated.

In addition to the aqueous silane dispersion/solution which was stirred for 30 minutes (Example 2a(i)) an additional silane solution was prepared for M3-ethoxy, which was stirred for only 2 minutes.

The resulting M3-ethoxy silane solution was then used to treat Mam1s (480 g) at different concentrations summarized in the below Table ‘5’:

TABLE 5
Summary for the various concentration of M3-ethoxy
silane used to treat the Mam1s silica and the time
taken for stirring the aqueous silane dispersion.

| M3-Ethoxy | Stirring Time |
|---|---|
| silane (%) | (Aq. Dispersion) |
| 0.1% | 30 minutes |
| 0.1% | 2 minutes |
| 0.2% | 2 minutes |
| 0.4% | 2 minutes |
| 0% | n/a |

Each treated sand from Table 5 was used to prepare molding materials with the PCL binder. A reference sample prepared with untreated Mam1s was also prepared. The 5 materials were molded and played with in contact with warm water (ca. 40° C.).

The sample prepared with untreated sand (i.e. 0% M3-ethoxy silane) immediately disintegrated and lost the sand filler. The 0.1% sample prepared with the “30 minutes” dispersion resisted the challenging treatment the best, showing that improved resistance is achieved through longer mixing times for the aqueous dispersion. For the “2 minutes” preparations, the 0.1% sample had the lowest tolerance and the 0.4% the highest, showing that improved resistance is achieved through higher concentrations of silane for the surface modified sand.

The Examples additionally show that also a monofunctional silane can provided enhanced properties to creative materials prepared with various polymer-based binders.

### Example 3a—One-Step Colorisation and Immobilization of X-Fast

Pigments/dyes which can be directly stirred into the aqueous silane dispersion can conveniently be used. One example is the BASF X-fast which include several color versions that are useful: For instance Xfast Blue 7080, Xfast Green 8730, Xfast Magenta 4790, Xfast Orange 2931, Xfast Red 3860, Xfast Violet 5895, Xfast White 0025, Xfast Yellow 1256, Xfast Black 0066.

TABLE 6a
Composition of final dispersion which was used to modify Mam1s.

| Component | Weight/g | Concentration/% wt |
|---|---|---|
| BS1701 | 0.5 | 12.3 |
| XL10 | 4.5 | |
| water | 32.45 | 79.9 |
| HAc(100%) | 0.048 | 0.12 |
| X-fast | 3.10 | 7.6 |
| SUM | 40.6 | 100 |

In a first test 0.5 g BS1701 and 4.5 g XL10 was dispersed in 16.25 g H₂O with 0.2 g HAc (24%), and 3.10 g X-fast was dissolved in 16.25 g H2O. These two solutions were mixed to the final composition, Table 6a, and added 3.9 g to 480 g (non-modified) Mam1s at a temperature of about 50° C. and mixed until water had evaporated. This gave concentrations of silane and X-fast on the sand of 0.10% and 0.062%, respectively. An extended testing of robustness involved contacting the ‘painted’ sand grains with:
Water
Molten Radiacid0406

The ‘painted’ sand grains resisted contact with both polar as well as non-polar solvents without leaking. This shows the pigments/dyes are immobilized.

A subjective evaluation of color strength is presented in Table 6b.

TABLE 6b
Various X-fast versions were used to colorize Mam1s by
using the above method (0.10% and 0.062% of silane and
X-fast on Mam1s, respectively). They were generally found
to be attached strongly to the sand grains' surfaces
virtually without leaking to polar or unipolar liquids.

| | | color |
|---|---|---|
| X-fast | color | strength |
| 0066 | black | weak to |
| | | medium |
| 2931 | orange | weak |
| 1256 | yellow | medium |
| 8730 | green | medium |
| 3860 | red | medium |
| 7080 | blue | medium |
| | | to strong |
| 4790 | magenta | medium |
| 5895 | violet | strong |
| 0025 | white | weak |

The few sand versions which were characterized by a weak color strength (for instance ‘orange’ in Table 6b) could successfully be treated with the double amount of the same dispersion (Table 6a). The higher X-fast concentration increased the color strength of the treated sand.

Colour strength may also be increased without increasing X-fast or silane concentration but instead by using a two-step surface treatment procedure as suggested in Example 1d. In a first step the sand is modified with a low level of silane, such as 0.03%. In a second step and in connection with coloration corresponding to 0.062% X-fast to sand, the silane/sand ratio can be 0.07%. In total it is 0.1% silane addition and 0.062% X-fast addition.

It is believed that all sand grains in the batch have a more similar color strength by using the two-step procedure than in the one step procedure where some sand grains are believed to have a weak coloration while others have a stronger coloration.

### Example 3b—Two-Step Colorisation and Immobilization of X-Fast

In a second method, a pigmenting step was conducted after the sand had received an initial surface-treated. For the pigmenting (second) step, silane HC303E was tested as an immobilizer of the X-fast stir in pigment preparations. The aqueous mixture in Table 7 was prepared and let to mix for about 1 h (to allow for a possible reaction between HC303E and the X-fast). The solution was added to already silane-treated Mam1s (BS1701 and XL10 at 0.1%) to the standard X-fast concentration of 0.062% (1.6 g of the dispersion to 480 g sand). Since HC303E comes as a 17% water solution, the HC303E concentration on the sand corresponds to ca. 0.0032%. The results are generally good and the pigments seem to stay strongly on the surfaces of the sand grains as verified by the same testing procedure as used above.

TABLE 7
HC303E comes as an aqueous dispersion, 17% in dry weight. Since
the dispersion is already stable, there was no need for adding
extra HAc. 1.6 g of this dispersion was added to 480 g already
hydrophobically modified sand followed by evaporation of water.

| Component | Weight/g | Concentration/% wt |
|---|---|---|
| X-fast | 5 | 18.9% |
| water | 20 | 80.1 |
| HC303E | 1.5 | 1.0 |
| SUM | 26.5 | 100 |

### Example 3c—Two-Step Colorisation and Immobilization of X-Fast with Trimethoxyphenylsilane and Triacetoxy(Vinyl)Silane

The effect of trimethyoxyphenylsilane and triacetoxy(vinyl)silane (GF62) surface treatment was assessed for the colourisation and immobilization of X-fast following the two-step method. The silane solution/dispersion was prepared followed a protocol closely like that of Example 1a. 5 g of silane was weighed out
The silane was added to an aqueous solution of 64 g water and 0.5 g HAc (24%) under vigorous stirring to provide a solution or dispersion
Mixing (vigorous) continued for ca. 30-60 minutes

The surface treated sand was then prepared in a two-step process. In the first step, the sand was modified with ca. 0.05% silane.
480 g of sand (Mam1s) was heated to 55-60° C. in a stainless-steel pot
3.4 g aqueous silane dispersion was added to the hot sand under mixing
Mixing continued until water had evaporated and the sand was dry

In the second step 0.3 g X-fast Blue 7080 was dissolved in 5 g of water and mixed with another 3.4 g of the aqueous silane dispersion, and was then added to the sand to provide in total ca. 0.1% silane and 0.06% X-fast in relation to the weight of the sand Mam1s:
The modified sand (above) was heated to ca. 55-60° C. in a stainless-steel pot
The aqueous X-fast Blue 7080/silane solution/dispersion was added to the hot sand under continued mixing
Mixing continued until water had evaporated and the sand was dry

The resulting sand has a rather strong blue colour and is virtually free from pigment leakage when the sand is contacted with excess water or ethanol during stirring with a magnetic bar.

### Example 3d—Two-Step Colourisation and Immobilization of X-Fast with M3-Ethoxy Silane

The aqueous dispersion of M3-ethoxy silane of Example 2a was used to surface treat sand:
480 g of sand (Mam1s) was heated to 55-60° C. in a stainless-steel pot
5 g of the silane M3-ethoxy dispersion was added to the hot sand under mixing
Mixing (vigorous) continued until dry

Colouration followed by preparing a sample of X-fast Blue 7080 (3 g) in water (30 g), wherein 3.3 g of the resulting solution was added to the hot sand and mixed until dry. Finally, another 5 g of the M3-ethoxy dispersion was added to the hot sand. The resulting sand comprises ca. 0.1% silane and ca. 0.06% X-fast.

After drying it was found that the coloured sand virtually had no leakage when contacted with excess water, despite vigorous stirring with a magnetic bar (2 g sand contacted with 40 mL water). A reference sample treated only with X-fast solution (0.06%) and no silane solution had pronounced leakage.

The challenge test was repeated with an aqueous solution comprising water (40 mL) and hand-dish washing liquid (0.5 mL). The difference between the monofunctional silane treated sample and the reference sample was very clear. While the silane treated sample only had very mild leakage of pigment, the sand treated with only X-fast Blue 7080 lost most of the pigmentation upon contact with the aqueous solution.

The results show that the monofunctional silane also helps immobilize the pigmentation on the surface of the particulate material.

### Example 3e—Two-Step Colourisation and Immobilization of X-Fast at a Larger Scale

For this experiment, while the scale is typical labscale (i.e. 480 g sand), the concentration of silane and concentration of pigment is a factor of 10 higher than the previous typical examples (i.e. now 1% and 0.6% compared to typical additions of 0.1 and 0.06% for the silane and pigment respectively.

The aqueous silane solution of Example 3c was prepared, wherein the silane was trimethoxyphenylsilane.
32 g of aqueous silane solution was added to 480 g Mam1s which was preheated to 55-60° C.
Mixing continued until water had evaporated and the sand was dry.

Meanwhile, 3 g of X-fast Blue 7080 was dissolved in 30 g water. The solution was mixed with the remaining 37 g silane solution, and the resulting mixture was added to the hot sand. The material was mixed until water had evaporated and the sand was dry. The resulting surface has ca. 1% silane and ca. 0.6% X-fast Blue on the sand surfaces.

The resulting sand was strongly coloured and when contacted with excess water under stirring stayed virtually uncoloured for several minutes. Wear of the surface colour layer was only seen for continued stirring wherein water phase slowly became blue in colour.

A reference sample without silane where the sand was only treated with an aqueous solution of X-fast had pronounced leakage and the excess water phase immediately obtained a strong blue colour. This shows that the surface modification process effectively immobilizes the pigments.

### Example 4—Low Staining from a Cohesive Sand-Like Moldable Material Prepared with Colored Sand

Preparation ‘X’ silicone binder was prepared by cross-linking 397 g C2T with 3.5 g ES23. The reaction took place during mixing the two components at a temperature of about 130° C. The crosslinking gave a strongly increased viscosity. The reaction was assumed completed after three hours.

0.4 g ‘X’ and 1.8 g CDS100 was added to a mix of 1.2 g K37 and 96 g sand (specified below) with a temperature of about 60° C. 0.4 g HCl(9%) was added together with 0.3 g Radiacid0406 which was melted and mixed in, followed by adding 0.1 g 120. As final step was 0.2 g SnS added to the mix. This gave a cohesive sand-like moldable material useful for children's play.

Sand was untreated Mamis or surface treated and colored Mamis from Example 3. Staining properties of the colored materials were subjectively evaluated. It was found there was virtually no, or very little staining to hands and tabletops from the moldable materials which generally have brilliant vivid colours.

Additionally, the Mamis treated sand (with trimethoxyphenylsilane or GF62) from Example 3c (95%) was mixed with polycaprolactone binder of Example 2B (5%) to provide reshapeable materials with a strong blue colour that had no staining to the hands when worked with. The materials are useful for children's play. Various silanes therefore can be used to surface modify sand and provide enhanced properties and coloured materials.

1. A method of colouring and surface treating at least one surface of a particulate material, the method comprising:
a) optionally heating the particulate material to a temperature between 3° and 85° C.;
b) preparing an aqueous dispersion of at least one material selected form a colourant, at least one alkoxy silane, at least one silyl alkanoate, at least one polysiloxane, and mixtures thereof;
c1) mixing the dispersion prepared in step b) with the particulate material of step a);
c2) optionally adding at least one material selected from at least one alkoxy silane, at least one silyl alkanoate, at least one polysiloxane, and mixtures thereof,
c3) heating the mixture to a temperature of between 2° and 80° C. for a period of 1 minute to 24 hours; and
d) optionally mixing the treated sand formed in step c) with an aqueous dispersion of at least one colourant and/or at least one alkoxy silane and/or at least one silyl alkanoate and/or at least one polysiloxane.
wherein steps a) (where used) and b) can be conducted simultaneously or sequentially in either order;
wherein at least one step includes the use of a material selected from at least one alkoxy silane, at least one silyl alkanoate, and/or least one polysiloxane;
wherein at least one step includes use of a colourant; and
wherein the aqueous dispersion of step d) may be the same or different to that of step b).

2. The method of colouring and surface treating of at least one surface of a particulate material, as claimed in claim 1, the method comprising;
a) optionally heating the particulate material to a temperature of between 3° and 85° C.;
b) preparing an aqueous dispersion of at least one alkoxy silane and/or at least one silyl alkanoate; and
c) mixing the dispersion prepared in step b) with the particulate material of step a) and heating the mixture to a temperature of between 2° and 80° C. for a period of 1 minute to 24 hours;
wherein steps a) (where used) and b) can be conducted simultaneously or sequentially in either order; and
d) mixing the treated sand formed in step c) with an aqueous dispersion of at least one colourant and optionally at least one alkoxy silane, at least one silyl alkanoate and/or at least one polysiloxane.

3. The method of colouring and surface treating at least one surface of at least one particulate material, as claimed in claim 1, the method comprising;
a) optionally heating the particulate material to a temperature of between 3° and 85° C.;
b) preparing an aqueous dispersion of: at least one alkoxy silane; and/or at least one silyl alkanoate; optionally at least one polysiloxane; and at least one colourant; and
c) mixing the dispersion prepared in step b) with the particulate material of step a) and heating the mixture to a temperature of between 2° and 80° C. for a period of 1 minute to 24 hours;
wherein steps a) (when used) and b) can be conducted simultaneously or sequentially in either order.

4. The method of colouring and surface treating at least one surface of at least one particulate material, as claimed in claim 1, the method comprising;
a) optionally heating the particulate material to a temperature of between 3° and 85° C.;
b) preparing an aqueous dispersion of: at least one colourant; and
c0) optionally pre-treating the particulate material with a basic solution
c1) mixing the dispersion prepared in step b) with the particulate material of step a)
c2) adding at least one material selected from at least one alkoxy silane, at least one silyl alkanoate, at least one polysiloxane, and mixtures thereof, and
c3) heating the mixture to a temperature of between 2° and 80° C. for a period of 1 minute to 24 hours;
wherein steps a) (when used) and b) can be conducted simultaneously or sequentially in either order.

5. The method of claim 1, wherein the dispersion of step b) and step d) where present comprises 0.5 to 30% by weight total silanes and 70 to 99.5% by weight water.

6. The method of claim 1, wherein the weight ratio of particulate material to total silanes is 90 to 99.99% particulate material and 0.01 to 10% total silanes.

7. The method of claim 1, wherein the at least one alkoxy silane comprise at least one alkoxy silane of formula (i 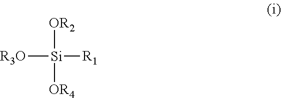
wherein:
R₁ is selected from H; CH₃; C₂ to C₁₂ branched or straight chain alkyl groups; C₂ to C₈ branched or straight chain alkenyl groups; C₂ to C₁₂ alkyl or alkenyl group comprising at least one ether link and/or at least one epoxy group; and/or C₅ to C₁₀ aromatic groups; and mixtures thereof;
each of R₂ and R₄ is independently selected from H; CH₃; C₂ to C₈ branched or straight chain alkyl groups; and mixtures thereof.

8. The method of claim 1, wherein the at least one silyl alkanoate comprise at least one silyl alkanoate of formula i: 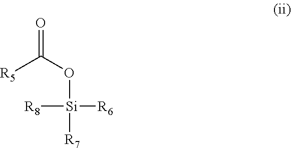
wherein R5 is selected from C1 to C6 alkyl groups, preferably a methyl group;
each of R6 and R7 is independently selected from R9, —O—R9 and —O—CO—R9, where R9 is selected from H; CH₃; C2 to C12 cyclic, branched or straight chain alkyl groups
and R8 is selected from H; CH₃; C2 to C12 cyclic, branched or straight chain alkyl groups; C2 to C12 branched or straight chain alkenyl groups and mixtures thereof;

9. The method of claim 1, wherein at least one alkoxy silane comprises i) at least one alkoxy vinyl silane and ii) at least one alkoxy alkyl silane.

10. The method of claim 1, wherein at least one alkoxy silane comprises i) at least one alkoxy vinyl silane and ii) at least one alkoxy alkyl silane at a weight ratio of i) to ii) between 99:1 and 50:50;

11. The method of claim 1, wherein step b) comprises:
b) Mixing i) at least one alkoxy vinyl silane and ii) at least one alkoxy alkyl silane in aqueous dispersion at a weight ratio of i) to ii) between 99:1 and 50:50.

12. The method of claim 11 wherein step b) additionally comprises mixing a colourant.

13. The method of claim 1, wherein the at least one alkoxy silane comprises i) trimethoxy vinyl silane and ii) triethoxy trimethylpentyl silane.

14. The method of claim 13 wherein triethoxy trimethylpentyl silane is present in an amount of 5 to 15% by weight of all silane compounds.

15. The method of claim 13 wherein trimethoxy vinyl silane is present in an amount of 85 to 95% by weight of all silane compounds.

16. The method of claim 1, wherein said particulate material comprises at least one metal oxide selected from silica, titania and/or alumina.

17. The method of claim 1, wherein said particulate material comprises or consists of at least one material selected from silica, quartz, soda-lime glass, borosilicate glass, building sand, silica sand, quartz sand, silica gel and/or fumed silica.

18. A method for improving the compatibility of a particulate material with a binder and concomitantly colouring the material, the method comprising
a) optionally heating the particulate material to a temperature of between 3° and 85° C.;
b) preparing an aqueous dispersion of at least one material selected from at least one alkoxy silane, at least one silylalkanoate, at least one polysiloxane and a colourant; and
c1) mixing the dispersion prepared in step b) with the particulate material of step a);
c2) optionally adding at least one material selected from at least one alkoxy silane, at least one silyl alkanoate, at least one polysiloxane, and mixtures thereof,
c3) heating the mixture to a temperature of between 2° and 80° C. for a period of 1 minute to 24 hours; and
d) optionally mixing the treated sand formed in step c) with an aqueous dispersion of at least one colourant and/or at least one alkoxy silane and/or at least one silyl alkanoate and/or at least one polysiloxane wherein steps a) and b) can be conducted simultaneously or sequentially in either order;
wherein at least one step c2) and/or d)) includes the use of a material selected from at least one alkoxy silane, at least one silyl alkanoate, and/or least one polysiloxane;
wherein the aqueous dispersion of step d) may be the same or different to that of step b); and
wherein at least one step includes a colourant.

19. The method for improving the compatibility of a particulate material with a binder as claimed in claim 18, which comprises or consists of a hydrophobic surface treatment as claimed in claim 1.

20. The method of claim 18 wherein said binder material contains at least one polymeric material.

21. The method of claim 20 wherein said at least one polymeric material is a polyester, polyvinyl ester or a polysiloxane.

22. The method of claim 21 wherein said polyester material is polycaprolactone.

23. The method of claim 21 wherein said polyvinyl ester material is polyvinyl acetate.

24. A particulate material surface modified on at least one surface with at least one silyl alkyl group or silyl alkenyl group and at least one colourant.

25. A particulate material of claim 24 where the particulate material is coloured on the at least one modified surface.

26. (canceled)

27. The particulate material of claim 24, wherein at least one modified surface is formed or formable by the method of claim 1.

28. The particulate material of claim 24, wherein the material is a surface-modified sand having a silica content of 80% to 100% by weight and an average particle size of 0.05 to 2 mm.

29-32. (canceled)

33. A filled moulding material comprising at least one coloured particulate filler material and at least one polymeric binder materials, wherein the particulate filler material has at least one treated surface, modified with at least one silyl alkyl group or silyl alkenyl group and at least one colourant.

34-36. (canceled)

37. The filled moulding material of claim 33, wherein the coloured particulate filler material has at least one treated surface formed or formable by the method of claim 1.
